(19) United States
(12) Patent Application Publication
(10) Pub. No.: US 2009/0200462 A1
(43) Pub. Date: Aug. 13, 2009

(54) SCANNING PROBE MICROSCOPE CAPABLE OF MEASURING SAMPLES HAVING OVERHANG STRUCTURE

(75) Inventors: Sang-il PARK, Seongnam-city (KR); Yong-Seok KIM, Seoul (KR); Jitae KIM, Anyang-city (KR); Sang Han CHUNG, Seoul (KR); Hyun-Seung SHIN, Incheon-city (KR); Jung-Rok LEE, Yongin-city (KR); Euichul HWANG, Seongnam-city (KR)

Correspondence Address: PATTERSON & SHERIDAN, L.L.P., 3040 POST OAK BOULEVARD, SUITE 1500, HOUSTON, TX, 77056, US

(73) Assignee: Park Systems Corp., Suwon (KR)

(21) Appl. No.: 12/393,293

(22) Filed: Feb. 26, 2009

Related U.S. Application Data
(63) Continuation-in-part of application No. 11/601,144, filed on Nov. 17, 2006.

(51) Int. Cl. G01N 23/00; G01N 13/10

(52) U.S. Cl. 250/306; 850/1

(57) ABSTRACT

A scanning probe microscope tilts the scanning direction of a z-scanner by a precise amount and with high repeatability using a movable assembly that rotates the scanning direction of the z-scanner with respect to the sample plane. The movable assembly is moved along a curved guide and has grooves that engage with corresponding projections on a stationary frame to precisely position the movable assembly at predefined locations along the curved guide.

### CROSS-REFERENCE TO RELATED APPLICATION(S)

This application is a continuation-in-part of U.S. patent application Ser. No. 11/601,144, filed Nov. 17, 2006.

### BACKGROUND OF THE INVENTION

Embodiments of the present invention generally relate to a to a scanning probe microscope (SPM), and more particularly, to an SPM which precisely analyzes characteristics of samples having an overhang surface structure.

Scanning probe microscopes (SPMs) have nano-scale resolution in order to show the shape of a surface of a sample or an electrical characteristic of the sample as an image. SPMs include atomic force microscopes (AFMs), magnetic force microscopes (MFMs), and scanning capacitance microscopes (SCMs). SPMs are used to analyze the shape of a surface of a sample or an electrical characteristic of the sample by moving a tip of a probe in contact with the surface of the sample or by moving the tip of the probe at a predetermined distance above the surface of the sample. However, in the case of a conventional scanning probe microscope, there is a problem in that the shape of a surface of a sample or an electrical characteristic of the sample cannot be precisely analyzed on a specific surface shape of the sample.

FIG. 1 is a schematic perspective view of a conventional scanning probe microscope. Referring to FIG. 1, a first scanner 31 and a second scanner 32 are attached to a frame 50. That is, the first scanner 31 is attached to a first frame 51 and the second scanner 32 is attached to a second frame 52. A probe 10 is attached to an end of the first scanner 31 and the first scanner 31 moves the probe 10 in a .+−.z-direction. A stage 20 is provided on the second scanner 32 and the second scanner 32 moves the stage 20 on an xy-plane. When a sample is disposed on the stage 20, the first scanner 31 moves the probe 10 in the .+−.z-direction and the second scanner 32 moves the stage 20, that is, the sample, on the xy-plane so that data related to the shape of a surface of the sample or an electrical characteristic of the sample can be obtained.

FIG. 2A is a schematic conceptual view for the case of analyzing a sample using the scanning probe microscope of FIG. 1. FIG. 2B is a schematic conceptual view of the shape of a surface of the sample obtained by analysis performed in FIG. 2A. FIG. 3A is a schematic conceptual view for the case of analyzing another sample using the scanning probe microscope of FIG. 1. FIG. 3B is a schematic conceptual view of the shape of a surface of the sample obtained by analysis performed in FIG. 3A.

Referring to FIGS. 2A and 2B, while a probe 10 attached to a carrier 15 moves so that a predetermined distance between a tip 12 placed on an end of a cantilever 11 of the probe 10 and the surface of a sample 20 can be kept (or while the tip 12 and the surface of the sample 20 are closely attached to each other), data related to the surface shape of the sample 20 are collected. Actually, while the sample 20 moves in an xy-plane using a second scanner 32 (see FIG. 1) and the probe 10 moves along a z-axis indicated by l1 using a first scanner 31 (see FIG. 1), data related to the sample 20 are collected. As a result, when the surface shape of the sample 20 is realized, the same shape 20′ as that of the sample 20 is realized, as illustrated in FIG. 2B.

However, if a sample has an overhang structure illustrated in FIG. 3A, correct data related to the sample cannot be obtained using the conventional scanning probe microscope. That is, while the probe 10 moves along the z-axis indicated by l1 using the first scanner 31 (see FIG. 1), data related to the sample 20 are collected. If a side surface 20a of the sample 20 is not a surface including the z-axis but is an inclined surface illustrated in FIG. 3, the probe 10 cannot scan the side surface 20a of the sample 20 having an overhang structure. Accordingly, when the surface shape of the sample 20 is realized using the conventional scanning probe microscope, there is a problem in that a different shape 20′ from that of the sample 20 is realized as illustrated in FIG. 3B.

To solve this problem, a method using a probe 10 illustrated in FIG. 4 has been proposed. That is, the probe 10 has a protrusion 10a on its front end so that correct data related to a sample 20 having an overhang structure can be obtained using the protrusion 10a. However, when using the probe 10, it is not easy to manufacture the probe 10. Excessive costs are required for its manufacture and the yield thereof is also low. In addition, since the probe 10 manufactured in such a way is not sharper than a conventional probe, there is a problem in that precise data related to a fine surface shape of nano-scale cannot be obtained. In the overhang structure of the sample, when the side surface 20a of the sample 20 is more inclined than the protrusion 10a of the probe 10, correct data related to the sample cannot be obtained even using the probe 10 illustrated in FIG. 4.

### SUMMARY OF THE INVENTION

One or more embodiments of the present invention provide a scanning probe microscope which precisely analyzes characteristics of samples having an overhang surface structure.

According to an aspect of the present invention, there is provided a scanning probe microscope including: a first probe; a first scanner changing a position of the first probe along a straight line; and a second scanner changing a position of a sample in a plane, wherein the straight line along which the position of the first probe is changed using the first scanner is non-perpendicular to the plane in which the position of the sample is changed using the second scanner.

The scanning probe microscope may further include a second probe, and a third scanner changing a position of the second probe along a different straight line from the straight line along which the position of the first probe is changed, and the straight line along which the position of the second probe is changed using the third scanner may be non-perpendicular to the plane in which the position of the sample is changed using the second scanner.

According to another aspect of the present invention, there is provided a scanning probe microscope including: a first probe; a first scanner changing a position of the first probe along a straight line; a second scanner changing a position of a sample in a plane; and a first actuator changing an angle formed between the straight line along which the position of the first probe is changed using the first scanner and the plane in which the position of the sample is changed using the second scanner.

The first actuator may change an angle formed between the straight line along which the position of the first probe is changed using the first scanner and the plane in which the position of the sample is changed using the second scanner, by moving the first scanner.

The scanning probe microscope may further include a frame supporting the first scanner, and the first actuator may change an angle formed between the straight line along which the position of the first probe is changed using the first scanner and the plane in which the position of the sample is changed using the second scanner, by moving the frame supporting the first scanner.

The scanning probe microscope may further include a second probe, a third scanner changing a position of the second probe along a different straight line from the straight line along which the position of the first probe is changed, and a second actuator changing an angle formed between the straight line along which the position of the second probe is changed using the third scanner and the plane in which the position of the sample is changed using the second scanner.

The first actuator may change an angle formed between the straight line along which the position of the first probe is changed using the first scanner and the plane in which the position of the sample is changed using the second scanner, by moving the first scanner, and the second actuator may change an angle formed between the straight line along which the position of the second probe is changed using the third scanner and the plane in which the position of the sample is changed using the second scanner, by moving the third scanner.

The scanning probe microscope may further include a frame supporting the first scanner and a frame supporting the third scanner, the first actuator may change an angle formed between the straight line along which the position of the first probe is changed using the first scanner and the plane in which the position of the sample is changed using the second scanner, by moving the frame supporting the first scanner, and the second actuator may change an angle formed between the straight line along which the position of the second probe is changed using the third scanner and the plane in which the position of the sample is changed using the second scanner, by moving the frame supporting the third scanner.

The scanning probe microscope may further include a rotating device rotating the first scanner by 180 degrees around an axis which is perpendicular to a plane in which a position of a sample is changed and which passes the first probe, or rotating the position of the sample by 180 degrees in a plane.

Further embodiments of the present invention provide a scanning probe microscope that can tilt the scanning direction of a z-scanner by a precise amount and with high repeatability.

A scanning probe microscope according to one of these further embodiments include a probe, a first scanner for changing a position of the probe along a straight line, and a second scanner for changing a position of a sample in a plane, wherein the first scanner is movable to one of multiple scanning positions, such that, for each of the scanning positions, the straight line along which the first scanner changes the position of the probe forms a different angle with respect to the plane in which the position of the sample is changed using the second scanner.

A scanning probe microscope according to another one of these further embodiments include a probe, a first scanner for changing a position of the probe along a straight line, a second scanner for changing a position of a sample in a plane, and a movable assembly for changing the angle formed between the straight line along which the first scanner changes the position of the probe and the plane in which the position of the sample is changed using the second scanner.

A scanning probe microscope according to another one of these further embodiments include a probe, a first scanner for changing a position of the probe along a straight line, the first scanner being mounted to a movable assembly such that the direction of the straight line with respect to a vertical axis changes as the movable assembly moves into different positions, and a second scanner for changing a position of a sample in a plane.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The above and other features and advantages of the present invention will become more apparent by describing in detail exemplary embodiments thereof with reference to the attached drawings in which:

FIG. 1 is a schematic perspective view of a conventional scanning probe microscope;

FIG. 2A is a schematic conceptual view for the case of analyzing a sample using the scanning probe microscope of FIG. 1;

FIG. 2B is a schematic conceptual view of the shape of a surface of the sample obtained by analysis performed in FIG. 2A;

FIG. 3A is a schematic conceptual view for the case of analyzing another sample using the scanning probe microscope of FIG. 1;

FIG. 3B is a schematic conceptual view of the shape of a surface of the sample obtained by analysis performed in FIG. 3A;

FIG. 4 is a schematic conceptual view for the case of analyzing a surface shape of a sample using another conventional scanning probe microscope;

FIG. 5 is a schematic perspective view of a scanning probe microscope according to an embodiment of the present invention;

FIGS. 6A, 6B, and 6C are schematic conceptual views for the case of analyzing a sample using the scanning probe microscope of FIG. 5;

FIG. 7 is a schematic perspective view of a scanning probe microscope according to another embodiment of the present invention;

FIG. 8 is a schematic perspective view of a scanning probe microscope according to another embodiment of the present invention;

FIG. 9 is a schematic perspective view of a scanning probe microscope according to another embodiment of the present invention;

FIG. 10A is a schematic perspective view of a scanning probe microscope according to another embodiment of the present invention;

FIG. 10B is a schematic conceptual view for the case of analyzing a sample using the scanning probe microscope of FIG. 10A;

FIG. 11 is a schematic side view of a scanning probe microscope according to another embodiment of the present invention;

FIG. 12 is a schematic conceptual view for the case of analyzing a sample using the scanning probe microprobe of FIG. 11;

FIG. 13 is a schematic perspective view of a scanning probe microscope according to another embodiment of the present invention;

FIGS. 14A-14D illustrate four different positions to which the movable assembly can be moved to tilt the probe scanning direction with respect to the vertical direction; and

FIG. 15 is a schematic perspective view of the rear of the movable assembly.

### DETAILED DESCRIPTION

The present invention will now be described more fully with reference to the accompanying drawings, in which exemplary embodiments of the invention are shown.

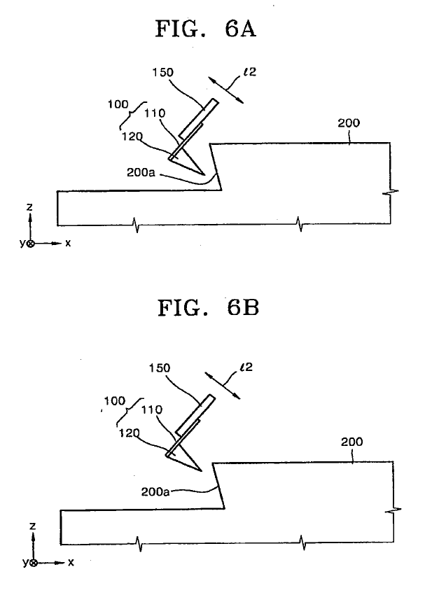

FIG. 5 is a schematic perspective view of a scanning probe microscope according to an embodiment of the present invention. Referring to FIG. 5, the scanning probe microscope includes a first probe 100, a first scanner 310, and a second scanner 320. Of course, if necessary, the scanning probe microscope may further include a frame 500 having a first frame 510 for supporting the first scanner 310 and a second frame 520 for supporting the second scanner 320, as illustrated in FIG. 5.

The first scanner 310 changes the position of the first probe 100 along a straight line l2, and the second scanner 320 changes the position of a sample 200 in a plane (an xy-plane). In this case, the straight line l2 in which the position of the first probe 100 is changed using the first scanner 310 is not perpendicular to the plane (the xy-plane) in which the position of the sample 200 is changed using the second scanner 320.

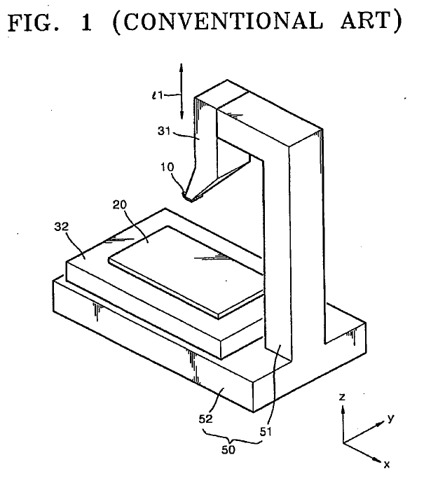

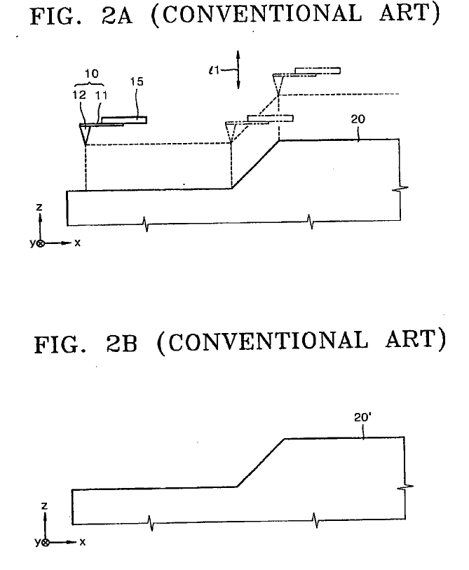

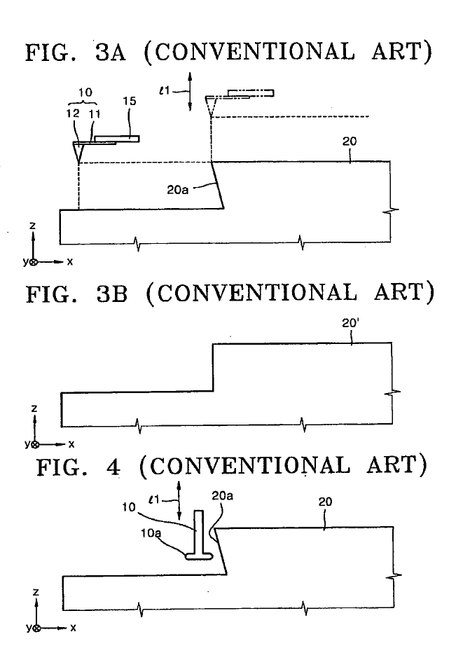

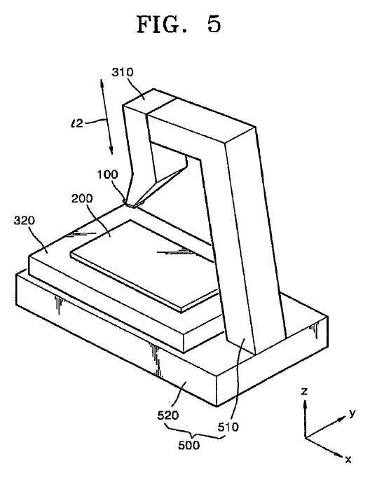

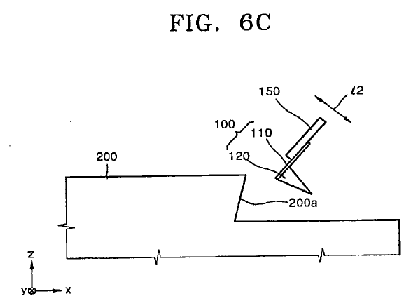

FIGS. 6A and 6B are schematic conceptual views for the case of analyzing a sample using the scanning probe microscope of FIG. 5. As illustrated in FIGS. 6A and 6B, a probe 100 may be attached to a carrier 150 if necessary. While the probe 100 moves so that a predetermined distance between a tip 120 placed on an end of a cantilever 110 of the probe 100 and the surface of a sample 200 can be kept (or while the tip 120 and the surface of the sample 200 are closely attached to each other), data related to the surface shape of the sample 200 are collected. Actually, while the sample 200 moves in an xy-plane using a second scanner 320 (see FIG. 5) and the probe 100 moves along a straight line indicated by l2 using a first scanner 310 (see FIG. 1), data related to the sample 200 are collected.

As described previously, in the case of the scanning probe microscope illustrated in FIG. 5, the straight line l2 in which the position of the first probe 100 is changed using the first scanner 310 is not perpendicular to the plane (the xy-plane) in which the position of the sample 200 is changed using the second scanner 320. Thus, even though the sample 200 has an overhang structure illustrated in FIGS. 6A and 6B, the tip 120 of the probe 100 can precisely scan a side surface 200a of the sample 200 so that data related to the surface of the sample 200 can be precisely collected. In addition, since components including a tip that has been used in the conventional scanning probe microscope can also be used without any changes in the scanning probe microscope illustrated in FIG. 5, a high-performance scanning probe microscope can be manufactured with the same yield as that of the prior art without an increase in manufacturing costs.

When data related to a sample are obtained using the scanning probe microscope illustrated in FIG. 5, with respect to the sample 200 having an overhang shape which is opposite to the overhang shape of the sample illustrated in FIGS. 6A and 6B and in which only a sample is rotated by 180 degrees in an xy-plane, as illustrated in FIG. 6C (not the sample 200 having an overhang shape illustrated in FIGS. 6A and 6B), the overhang-shaped side surface 200a of the sample 200 may not be precisely scanned. Thus, to solve the problem, the scanning probe microscope illustrated in FIG. 5 may further include a rotating device for rotating the sample 200 by 180 degrees within the xy-plane. By rotating the sample 200 illustrated in FIG. 6C using the rotating device, the overhang structure of the sample 200 may be placed with respect to the straight line l2 in which the position of the probe 100 is changed using the first scanner 310, as illustrated in FIG. 6A or 6B. Of course, a variety of modifications like that the rotating device may also rotate the first scanner 310, are possible. That is, the rotating device may also rotate the first scanner by 180 degrees around an axis which is perpendicular to the plane (the xy-plane) where the position of the sample is changed and which passes the probe 100. In addition, this configuration may also be applied to the scanning probe microscope according to another embodiments which will be described later, as well as the scanning probe microscope illustrated in FIG. 5.

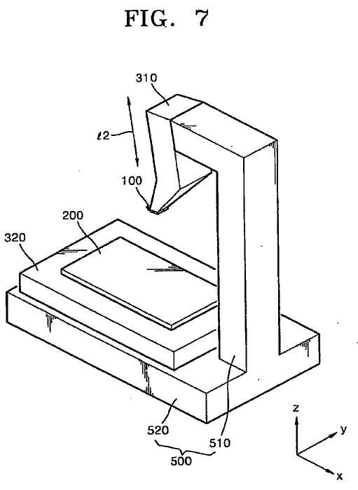

In the scanning probe microscope illustrated in FIG. 5, the first frame 510 for supporting the first scanner 310 is inclined so that the straight line l2 in which the position of the first probe 100 is changed using the first scanner 310 can be non-perpendicular to the plane (the xy-plane) in which the position of the sample 200 is changed using the second scanner 320. However, various modifications that are different from the scanning probe microscope illustrated in FIG. 5 are possible. For example, like a scanning probe microscope illustrated in FIG. 7 according to another embodiment of the present invention, the first scanner 310 itself is non-perpendicular to the plane (the xy-plane) in which the position of the sample 200 is changed using the second scanner 320 so that the straight line l2 in which the position of the first probe 100 is changed using the first scanner 310 can also be non-perpendicular to the plane (the xy-plane) in which the position of the sample 200 is changed using the second scanner 320.

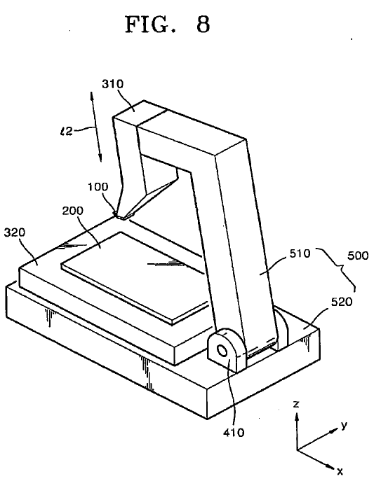

Meanwhile, an angle formed between the plane (the xy-plane) in which the position of the sample is changed using the second scanner and the side surface of the sample having the overhang structure may be different according to samples. In this case, in order to obtain correct data related to the sample in the overhang structure of the sample, an angle formed between the straight line along which the position of the first probe is changed using the first scanner and the plane (the xy-plane) in which the position of the sample is changed using the second scanner needs to be properly adjusted according to the overhang structure of the sample. Thus, like a scanning probe microscope illustrated in FIG. 8 according to another embodiment of the present invention, the scanning probe microscope may further include a first actuator 410. The first actuator 410 serves to change an angle formed between the straight line l2 in which the position of the first probe 100 is changed using the first scanner 310 and the plane (the xy-plane) in which the position of the sample 200 is changed using the second scanner 320.

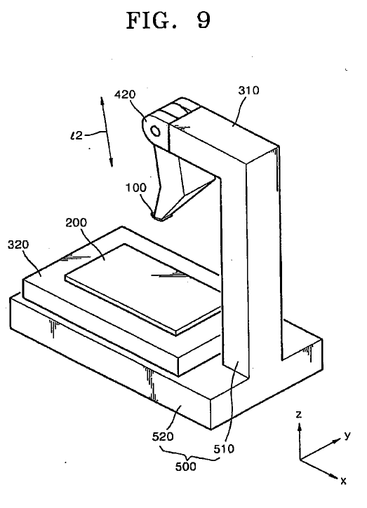

In the case of the scanning probe microscope illustrated in FIG. 8, the first actuator 410 moves the first frame 510 for supporting the first scanner 310 so that an angle formed between the straight line l2 in which the position of the first probe 100 is changed using the first scanner 310 and the plane (the xy-plane) in which the position of the sample 200 is changed using the second scanner 320, can be changed. However, various modifications that are different from the scanning probe microscope of FIG. 8 are possible. For example, like a scanning probe microscope illustrated in FIG. 9 according to another embodiment of the present invention, the first actuator 410 moves the first scanner 310 so that an angle formed between the straight line l2 in which the position of the first probe 100 is changed using the first scanner 310 and the plane (the xy-plane) in which the position of the sample 200 is changed using the second scanner 320 can also be changed.

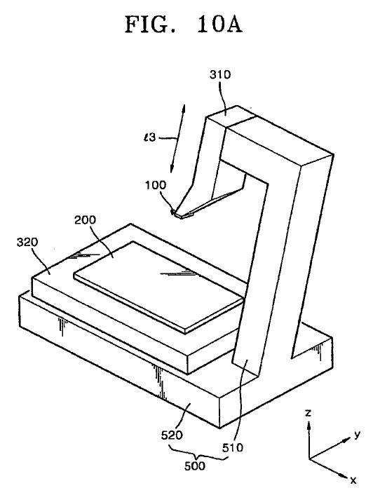

Meanwhile, in FIGS. 5, 7, 8, and 9, the straight line l2 in which the position of the first probe 100 is changed using the first scanner 310 of the scanning probe microscope is inclined in an −x-axis direction based on a coordinate system illustrated in each drawing of FIGS. 5, 7, 8, and 9 with respect to a straight line l1 in which the position of the probe 10 is changed using the first scanner 31 in the conventional scanning probe microscope illustrated in FIG. 1. However, the scanning probe microscope according to the present invention is not limited to this. That is, like a scanning probe microscope illustrated in FIGS. 10A and 10B according to another embodiment of the present invention, a straight line l3 in which the position of the first probe 100 is changed using the first scanner 310 may also be inclined in a y-axis direction based on the coordinate system illustrated in each drawing of FIGS. 5, 7, 8, 9, and 10A, with respect to the straight line l1 in which the position of the probe 10 is changed using the first scanner 31 in the conventional scanning probe microscope illustrated in FIG. 1. That is, the scanning probe microscope according to the present invention is sufficient that the straight line along which the position of the first probe is changed using the first scanner is non-perpendicular to the plane in which the position of the sample is changed using the second scanner. Alternatively, the scanning probe microscope according to the present invention is sufficient that an angle formed between the straight line along which the position of the first probe is changed using the first scanner and the plane in which the position of the sample is changed using the second scanner may be changed by the first actuator.

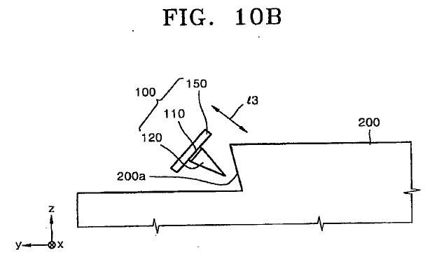

FIG. 11 is a schematic side view of a scanning probe microscope according to another embodiment of the present invention.

The scanning probe microscopes according to the above-described embodiments of FIGS. 5, 7, 8, 9, and 10A, a probe is one and the probe moves in a straight line using the first scanner. However, the scanning probe microscope illustrated in FIG. 11 further includes a second probe 100′ except for the first probe 310. And, the scanning probe microscope of FIG. 11 includes a third scanner 310′, and the third scanner 310′ changes the position of the second probe 100′ in a straight line l2′ that is different from a straight line l2 in which the position of the first probe 100 is changed using the first scanner 310. Of course, the straight line l2′ in which the position of the second probe 100′ is changed using the third scanner 310′ is non-perpendicular to the plane (the xy-plane) in which the position of the sample 200 is changed using the second scanner 320. In this case, the straight line l2 in which the position of the first probe 100 is changed using the first scanner 310 is changed and the straight line l2′ in which the position of the second probe 100′ is changed using the third scanner 310′ are on the same plane.

As described previously with reference to FIGS. 6A, 6B, and 6C, a position relationship between a direction where the side surface of the sample in the overhang shape of the sample is inclined and a straight line where the position of the probe is changed should be decided so that correct data related to the sample can be obtained. Thus, as illustrated in FIG. 11, the scanning probe microscope includes the first probe 100 and the second probe 100′ and the straight line l2 in which the position of the first probe 100 is changed using the first scanner 310′ and the straight line l2′ in which the position of the second probe 100′ is changed using the third scanner 310′ are different from each other so that correct data related to side surfaces inclined in various directions in the overhang shape of the sample 200 can be obtained without rotating the sample 200.

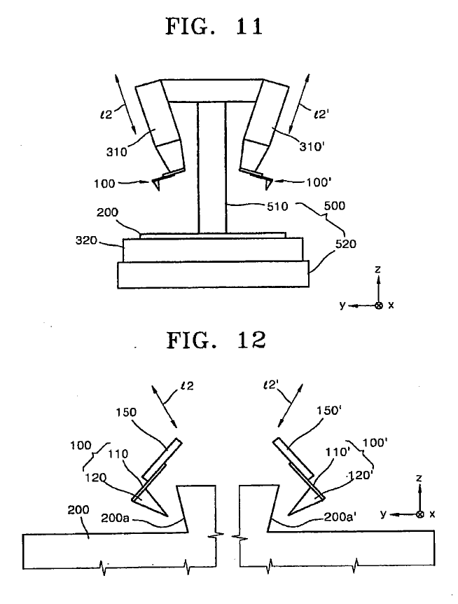

FIG. 12 is a schematic conceptual view for the case of analyzing a sample 200 using the scanning probe microscope of FIG. 11. It can be understood that correct data related to differently-inclined side surfaces 200a and 200a′ can be obtained.

Of course, such a modification is not limited to the scanning probe microscope illustrated in FIG. 11. That is, as described in the above-described embodiments of FIGS. 5, 7, 8, 9, 10A, and 11, the scanning probe microscope of FIG. 12 may include a first actuator for moving a first scanner 310 and further include a second actuator for moving a third scanner 310′. In addition, of course, various modifications like that the first scanner 310 may be supported by a first frame, the third scanner 310′ may be supported by a third frame, the first actuator may move the first frame for supporting the first scanner, and the second actuator may move the third frame for supporting the third scanner, are possible.

By using the scanning probe microscope according to the above-described embodiments of FIGS. 5, 7, 8, 9, 10A, and 11, even though a sample has an overhang structure, a tip of a probe can precisely scan a side surface of the sample having the overhang structure such that correct data related to the surface of the sample are collected. In addition, components including a tip that has been used in the conventional scanning probe microscope can also be used without any changes such that a high-performance scanning probe microscope is manufactured with the same yield without an increase in manufacturing costs.

As described above, according to the scanning probe microscope according to the present invention, characteristics of samples having an overhang structure can be precisely and correctly analyzed.

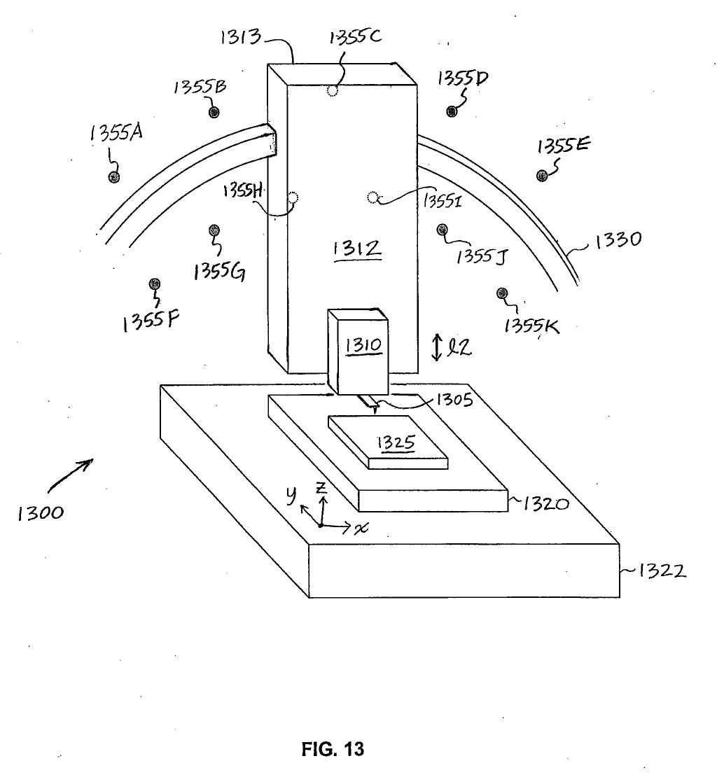

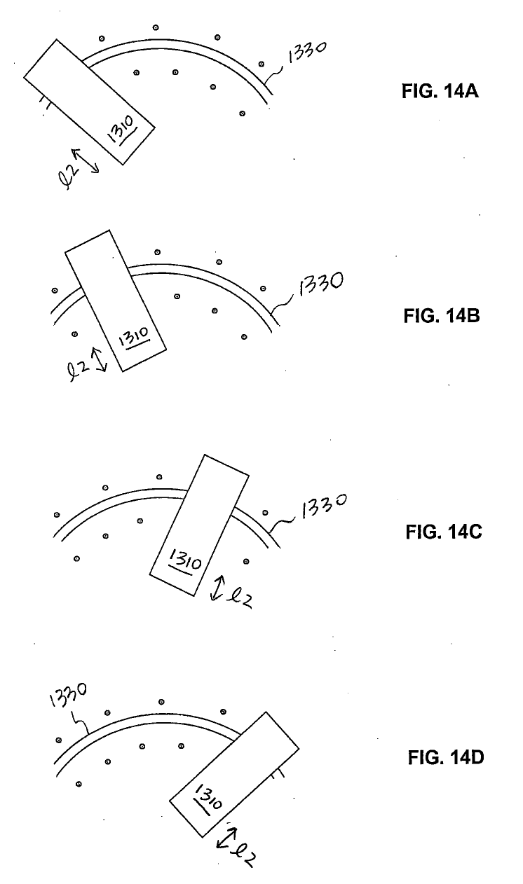

FIG. 13 is a schematic perspective view of a scanning probe microscope 1300 according to another embodiment of the present invention. The scanning probe microscope 1300 includes a probe 1305, a first scanner 1310 attached to a movable assembly 1312, and a second scanner 1320 attached to a base 1322. The first scanner 1310 changes the position of the probe 1305 along a straight line l2, and the second scanner 1320 changes the position of a sample 1325 in a plane (e.g., an xy-plane or horizontal plane). In FIG. 13, the straight line l2 along which the position of the probe 1305 is changed using the first scanner 1310 is perpendicular to the plane in which the position of the sample 1325 is changed using the second scanner 1320. FIGS. 14A-14D show other scanning positions of the first scanner 1310. In these other scanning positions, the first scanner 1310 changes the position of the probe 1305 along a straight line l2 which is not perpendicular to the plane in which the position of the sample 1325 is changed using the second scanner 1320.

In the scanning positions shown in FIGS. 14A and 14D, the straight line l2 forms a 52-degree angle with the plane in which the position of the sample 1325 is changed using the second scanner 1320. In the scanning positions shown in FIGS. 14B and 14C, the straight line l2 forms a 71-degree angle with the plane in which the position of the sample 1325 is changed using the second scanner 1320. The scanning direction of the first scanner 1310 having the scanning position shown in FIG. 14A and the scanning direction of the first scanner 1310 having the scanning position shown in FIG. 14D are symmetrical with respect to a vertical plane. Similarly, the scanning direction of the first scanner 1310 having the scanning position shown in FIG. 14B and the scanning direction of the first scanner 1310 having the scanning position shown in FIG. 14C are symmetrical with respect to a vertical plane.

The first scanner 1310 attains the different scanning positions shown in FIG. 13 and FIGS. 14A-14D when the movable assembly 1312 is moved along a curved guide 1330 to one of five different positions along the curved guide 1330 and is engaged with hemispherical projections 1355A-K (collectively referred to as 1355) formed on a stationary frame 1350, as further described below. For simplicity, the drive mechanism for the movable assembly 1312 is not shown in any of the figures. Any drive mechanism known in the art that is capable of moving the movable assembly 1312 along the curved guide 1330 may be used. In addition, to minimize the variance of the probe position with respect to the sample 1325 as the movable assembly 1312 is moved along the curved guide 1330, the probe 1305 is mounted at or near the center point of a rotational arc that is defined by the movement of the movable assembly 1312 along the curved guide 1330.

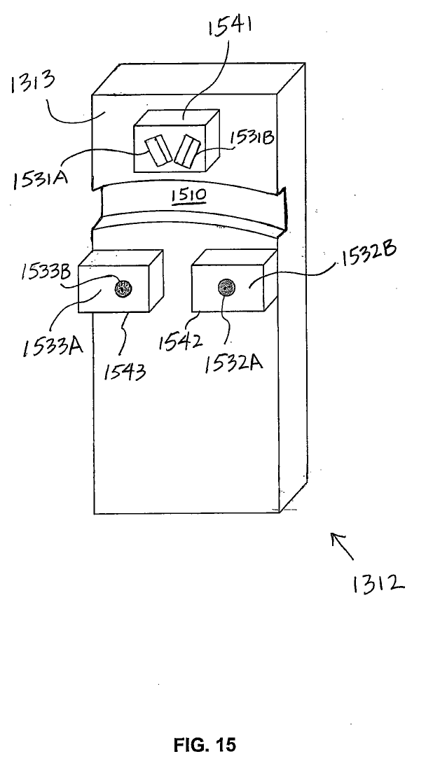

FIG. 15 is a schematic perspective view of the rear of the movable assembly 1312 and shows a curved slot 1510 by which the movable assembly 1312 rides along the curved guide 1330. After the movable assembly 1312 is moved to a desired position, it is maintained at that position with respect to the stationary frame 1350 by two means. The first is a vacuum (or alternatively, a magnetic force) applied between a rear surface 1313 of the movable assembly 1312 and the curved guide 1330. The second is the engagement of: (1) v-groove 1531A or 1531B formed on extension arm 1541 of the movable assembly 1312 with a corresponding hemispherical projection 1355 formed on the stationary frame 1350, and (2) conic groove 1532A formed on extension arm 1542 of the movable assembly 1312 or conic groove 1533B formed on extension arm 1543 of the movable assembly 1312 with a corresponding hemispherical projection 1355 formed on the stationary frame 1350. A flat surface 1533A or 1532B formed on extension arm 1543 also contacts a corresponding hemispherical projection 1355 formed on the stationary frame 1350.

Before the movable assembly 1312 is moved between positions, the vacuum (or magnetic force) applied between the movable assembly 1312 and the curved guide 1330 is released. Then, the movable assembly 1312 is driven to a new position and the vacuum (or magnetic force) is reapplied between the movable assembly 1312 and the curved guide 1330. When the vacuum (or magnetic force) is reapplied between the movable assembly 1312 and the curved guide 1330, the grooves 1531A (or 1531B) and 1532A (or 1533B) engage with their corresponding hemispherical projections 1355 and compensate for any small positioning errors. As a result, precise angular tilt of the scanning direction of the first scanner 1310 can be achieved with high repeatability.

The table below shows, for each of the different scanning positions of the first scanner 1310: (1) the angle formed between scanning direction of the first scanner 1310 and the plane in which the position of the sample 1325 is changed using the second scanner 1320, (2) the points on the movable assembly 1312 that contact the hemispheric projections 1355 formed on the stationary frame 1350, and (3) the hemispheric projections 1355 formed on the stationary frame 1350 that are engaged with or otherwise contact the movable assembly 1312.

| Position | Angle | Contact 1 | Contact 2 | Contact 3 |
|---|---|---|---|---|
| 1 | 52.0 | groove 1531A | groove 1532A | flat surface |
| | | with projection | with projection | 1533A with |
| | | 1355A | 1355F | projection 1355G |
| 2 | 71.0 | groove 1531A | groove 1532A | flat surface |
| | | with projection | with projection | 1533A with |
| | | 1355B | 1355G | projection 1355H |
| 3 | 90.0 | groove 1531A | groove 1532A | flat surface |
| | | with projection | with projection | 1533A with |
| | | 1355C | 1355H | projection 1355I |
| 4 | 71.0 | groove 1531B | flat surface | groove 1533B |
| | | with projection | 1532B with | with projection |
| | | 1355D | projection 1355I | 1355J |
| 5 | 52.0 | groove 1531B | flat surface | groove 1533B |
| | | with projection | 1532B with | with projection |
| | | 1355E | projection 1355J | 1355K |

Without departing from the scope of the invention, the number of predefined positions to which the movable assembly 1312 can be moved can be more or less than 5. If there is less than 5, a smaller number of hemispheric projections 1355 will be needed. If there is more than 5, a greater number of hemispheric projections 1355 will be needed. In addition, the location of the hemispheric projections 1355 on the stationary frame 1350 may be changed in other embodiments to alter by any desired amount the scanning direction of the first scanner 1310 (and so the angle formed between the scanning direction of the first scanner 1310 and the plane in which the position of the sample 1325), when the movable assembly 1312 moves into position and engages with the hemispheric projections 1355 at a modified location.

In one alternative embodiment, the number of predefined positions to which the movable assembly 1312 can be moved is 3, and the angles formed between the scanning direction of the first scanner 1310 and the plane in which the position of the sample 1325, when the movable assembly 1312 moves into the predefined positions, are 90 degrees and +/−50 degrees.

While the foregoing is directed to embodiments of the present invention, other and further embodiments of the invention may be devised without departing from the basic scope thereof, and the scope thereof is determined by the claims that follow.

We claim:

1. A scanning probe microscope comprising:
a probe;
a first scanner for changing a position of the probe along a straight line; and
a second scanner for changing a position of a sample in a plane,
wherein the first scanner is movable to one of multiple scanning positions, such that, for each of the scanning positions, the straight line along which the first scanner changes the position of the probe forms a different angle with respect to the plane in which the position of the sample is changed using the second scanner.

2. The scanning probe microscope of claim 1, wherein the straight line along which the first scanner changes the position of the probe is perpendicular to the plane in which the position of the sample is changed using the second scanner when the first scanner is moved to one of the multiple scanning positions, but is non-perpendicular at all other scanning positions.

3. The scanning probe microscope of claim 1, wherein the position of the probe with respect to the sample remains substantially the same when the first scanner is moved to each of the multiple scanning positions.

4. The scanning probe microscope of claim 1, wherein each of the multiple scanning positions is predefined.

5. The scanning probe microscope of claim 4, further comprising a movable assembly to which the first scanner is mounted, wherein the first scanner is moved to each of the predefined multiple scanning positions using the movable assembly.

6. The scanning probe microscope of claim 5, wherein the movable assembly has grooves that engage with corresponding projections on a stationary frame.

7. The scanning probe microscope of claim 6, wherein the movable assembly has a v-groove that engages with one of the projections on the stationary frame and a conic groove that engages with another one of the projections on the stationary frame.

8. A scanning probe microscope comprising:
a probe;
a first scanner for changing a position of the probe along a straight line;
a second scanner for changing a position of a sample in a plane; and
a movable assembly for changing the angle formed between the straight line along which the first scanner changes the position of the probe and the plane in which the position of the sample is changed using the second scanner.

9. The scanning probe microscope of claim 8, wherein the movable assembly has grooves that engage with corresponding projections on a stationary frame.

10. The scanning probe microscope of claim 9, wherein the movable assembly has a v-groove that engages with one of the projections on the stationary frame and a conic groove that engages with another one of the projections on the stationary frame.

11. The scanning probe microscope of claim 8, wherein the movable assembly is moved to change the angle formed between the straight line along which the first scanner changes the position of the probe and the plane in which the position of the sample is changed using the second scanner, into one of multiple predefined angles.

12. The scanning probe microscope of claim 11, wherein the first predefined angle is 90 degrees and all other predefined angles are less than 90 degrees.

13. The scanning probe microscope of claim 12, wherein the movable assembly is moved to multiple predefined positions, each of the predefined positions being associated with one of the predefined angles.

14. The scanning probe microscope of claim 13, wherein the movable assembly has grooves that engage with corresponding projections on a stationary frame when it moves to any of the predefined positions.

15. A scanning probe microscope comprising:
a probe;
a first scanner for changing a position of the probe along a straight line, the first scanner being mounted to a movable assembly such that the direction of the straight line with respect to a vertical axis changes as the movable assembly moves into different positions; and
a second scanner for changing a position of a sample in a plane.

16. The scanning probe microscope of claim 15, wherein the movable assembly has three points of contact with a stationary frame, the first contact point being a v-groove, the second contact point being a flat surface, and the third contact point being a conic groove.

17. The scanning probe microscope of claim 16, wherein the stationary frame has a plurality of projections that contact the contact points of the movable assembly.

18. The scanning probe microscope of claim 17, wherein the projections have a spherical shape.

19. The scanning probe microscope of claim 17, wherein some of the projections contact the movable assembly when the movable assembly is moved into one of the different positions and when the movable assembly is moved into another one of the different positions.

20. The scanning probe microscope of claim 16, wherein the movable assembly has two v-grooves, only one of which is used at any one position of the movable assembly.
